(19) United States
(12) Patent Application Publication
(10) Pub. No.: US 2005/0084833 A1
(43) Pub. Date: Apr. 21, 2005

(54) Surgical training simulator

(76) Inventors: Gerard Lacey, County Wicklow (IE); Derek Young, County Dublin (IE); Derek Cassidy, County Cavan (IE); Fiona Slevin, Dublin (IE); Donncha Ryan, Dublin (IE)

Correspondence Address: JACOBSON HOLMAN PLLC, 400 SEVENTH STREET N.W., SUITE 600, WASHINGTON, DC, 20004, US

(21) Appl. No.: 10/983,740

(22) Filed: Nov. 9, 2004

Related U.S. Application Data
(63) Continuation of application No. PCT/IE03/00069, filed on May 12, 2003.

(30) Foreign Application Priority Data
May 10, 2002 (IE) 2002/0376

(51) Int. Cl. G09B 23/28

(52) U.S. Cl. 434/262

(57) ABSTRACT

A simulator (1) has a body form apparatus (2) with a skin-like panel (4) through which laproscopic instruments (5) are inserted. Cameras (10) capture video images of internal movement of the instruments (5) and a computer (6) processes them. 3D positional data is generated using stereo triangulation and is linked with the associated video images. A graphics engine (60) uses the 3D data to generate graphical representations of internal scenes. A blending function (70) blends real and recorded images, or real and simulated images to allow demonstration of effects such as internal bleeding or suturing.

### FIELD OF THE INVENTION

The invention relates to laproscopic surgical training.

### PRIOR ART DISCUSSION

It is known to provide a surgical training simulator, as described in U.S. Pat. No. 5,623,582. In this simulator a surgical instrument is supported on a universal joint and encoders monitor rotation of the instrument in 3D. However, it appears that this simulator suffers from allowing limited movement confined by the joint characteristics, limited simulation of the real situation in which the instrument is inserted through a patient's skin, and the fact that there is no relationship between the positions of the joints and the organs of a patient's body.

PCT Patent Specification WO02/059859 describes a system which automatically retrieves a stored video sequence according to detected interactions.

The invention is therefore directed towards providing an improved surgical training simulator which simulates more closely the real situation and/or which provides more comprehensive training to a user.

### SUMMARY OF THE INVENTION

According to the invention, there is provided a surgical training simulator comprising:
a body form apparatus comprising a body form allowing entry of a surgical instrument;
an illuminator;
a camera for capturing actual images of movement of the surgical instrument within the body form apparatus;
an output monitor for displaying captured images; and
a processor comprising:
   a motion analysis engine for generating instrument positional data and linking the data with associated video images, and
   a processing function for generating output metrics for a student according to the positional data.

In one embodiment, the simulator comprises a plurality of cameras mounted for capturing perspective views of a scene within the body form apparatus.

In another embodiment, a camera comprises an adjustment handle.

In a further embodiment, the body form apparatus comprises a panel of material simulating skin, and through which an instrument may be inserted.

In one embodiment, the motion analysis engine uses a stereo triangulation technique to determine positional data.

In another embodiment, the motion analysis engine determines instrument axis of orientation and linear position on that line.

In a further embodiment, the motion analysis engine monitors an instrument marking to determine degree of rotation about the axis of orientation.

In one embodiment, the motion analysis engine initially searches in a portion of an image representing a top space within the body form apparatus, and proceeds with a template matching operation only if a pixel pattern change is located in said image top portion.

In another embodiment, the motion analysis engine manipulates a linear pattern of pixels to compensate for camera lens warp before performing stereo triangulation.

In a further embodiment, the surgical training simulator further comprises a graphics engine for receiving the positional data and using it to generate a virtual reality simulation in a co-ordinate reference space common to that within the body form apparatus.

In one embodiment, the graphics engine renders each organ as an object having independent attributes of space, shape, lighting and texture.

In another embodiment, a scene manager of the graphics engine by default creates a static scene of all simulated organs in a static position from a camera angle of one of the actual cameras.

In a further embodiment, the graphics engine renders an instrument model, and simulates instrument movement according to the positional data.

In one embodiment, the graphics engine simulates organ surface distortion if the instrument positional data indicates that the instrument enters space of the simulated organ.

In another embodiment, the graphics engine comprises a view manager which changes simulated camera angle according to user movements.

In a further embodiment, the processor comprises a blending function for compositing real and recorded images according to overlay parameter values.

In one embodiment, the blending function blends real video images with simulated images to provide a composite video stream of real and simulated elements.

In another embodiment, the graphics engine generates simulated images representing internal surgical events such as bleeding, and the blending function composites real images with said simulated images.

In a further embodiment, the processor synchronises blending with generation of metrics for simultaneous display of metrics and blended images.

In one embodiment, the processor feeds positional data simultaneously to the graphics engine and to a processing function, and feeds the associated real video images to the blending function.

In another embodiment, the graphics engine generates graphical representations from low-bandwidth positional data, the motion analysis engine generates said low-bandwidth positional data, and the system further comprises an interface for transmitting said low bandwidth positional data to a remote second simulator and for receiving low bandwidth positional data from the second simulator.

In a further embodiment, the graphics engine renders a view of simulated organs with a viewing angle driven by the position and orientation of a model endoscope inserted in the body form apparatus. Both end view and angle endoscope simulated views may be produced.

In one embodiment, the motion analysis engine monitors movement of actual objects within the body form apparatus as the objects are manipulated by an instrument.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a perspective view from above showing a surgical training simulator in use;

FIG. 2 is a cross-sectional elevational view and FIG. 3 is a cross-sectional plan view of a body form apparatus of the simulator;

FIG. 4 is a diagram illustrating direction for tracking 3D instrument position;

FIG. 5 is a block diagram showing the primary inputs and outputs of a computer of the simulator; and

FIGS. 6 to 10 are flow diagrams illustrating image processing operations for operation of the simulator.

### DESCRIPTION OF THE EMBODIMENTS

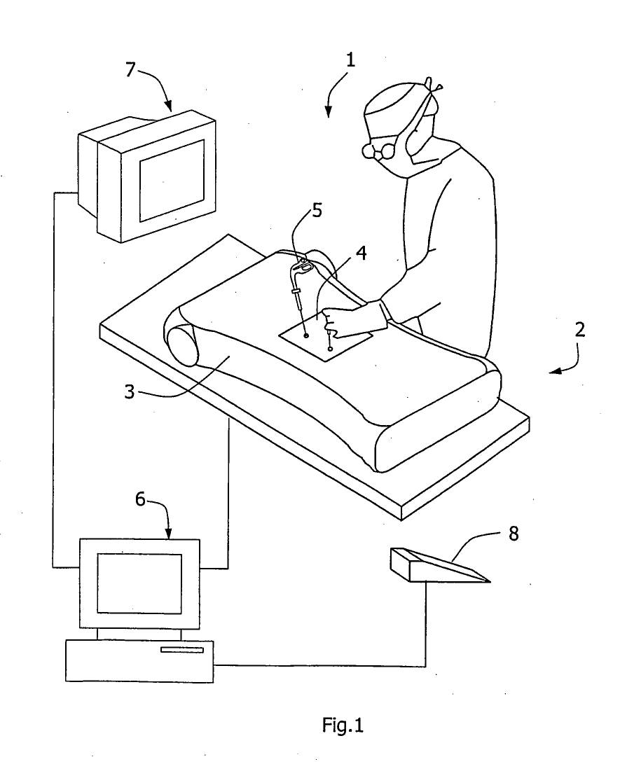

Referring to FIGS. 1 to 3 a surgical training simulator 1 of the invention comprises a body form apparatus 2 having a plastics torso body form 3 and a panel 4 of flexible material that simulates skin. Laproscropic surgical instruments 5 are shown extending through small apertures in the panel 4. The body form apparatus 2 is connected to a computer 6, in turn connected to an output display monitor 7 and to an input foot pedal 8. The main purpose of the foot pedal 8 is to allow inputs equivalent to those of a mouse, without the user needing to use his or her hands.

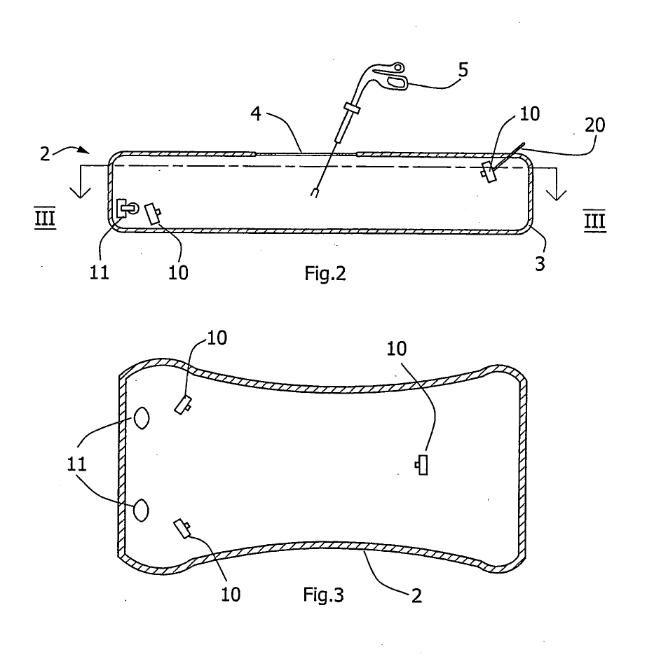

As shown in FIGS. 2 and 3, the body form apparatus 2 comprises three cameras 10, two at the “top” end and one at the “lower” end, to capture perspective views of the space in which the instruments 5 move. They are located to provide a large degree of versatility for location of the instruments 5, so that the instruments can extend through the panel 4 at any desired location corresponding to the real location of the relevant organ in the body. The locations of the cameras may be different, and there may be only two or greater than three in number.

Two fluorescent light sources 11 are mounted outside of the used space within the body form apparatus 2. The light sources operate at 40 kHz, and so there is no discernable interference with image acquisition (at a frequency of typically 30-60 Hz). One of the cameras 10 has an adjustment handle 20 protruding from the body form 3, although more of the cameras may have such an adjustment mechanism in other embodiments.

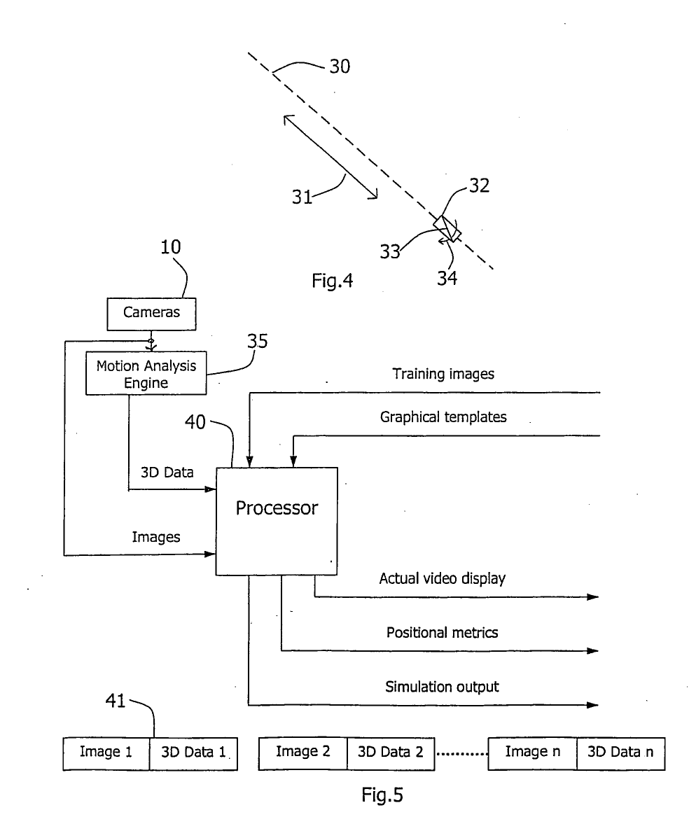

The cameras 10 are connected to the computer 6 to provide images of movement of the instruments 5 within the body form 3. The computer 6 uses stereo triangulation techniques with calibration of the space within the body form 3 to track location in 3D of each instrument 5. Referring to FIG. 4, the computer 6 determines:
(a) the current axial direction 30 (i.e. orientation of the line 30) of the instrument, and
(b) the depth of insertion of the instrument 5 along the axis 30 in the direction of the arrows 31.

A part, 32, of the instrument has a tapered marking 33 which allows the computer 6 to monitor rotation, depth of insertion about the axis 30 as indicated by an arrow 34, and to uniquely identify each instrument 5.

Referring to FIG. 5 the cameras 10 feed live video into a motion analysis engine 35 and into processing functions 40 of the computer 6. The motion analysis engine 35 generates 3D position data for each instrument. This is performed using stereo triangulation such as that described in the paper “An Efficient and Accurate Camera Calibration Technique for 3D Machine Vision”, Roger Y. Tsai, Proceedings of IEEE Conference on Computer Vision and Pattern Recognition, Miami Beach, Fla., 1986, pages 364-374. The motion analysis engine (35) analyses the top part of the image initially corresponding to space immediately below the “skin” 4 and performs template matching using linear templates having shapes similar to those of instruments, to locate and track the movement of the instruments. The engine 35 de-warps the instrument pixels to compensate for lens warp. The differences between the “empty box” image and the image taken with the instruments inserted represent the regions occupied by the instruments. Using these regions as start points the features of the instruments and their locations are extracted. Three dimensional position data is generated by stereo triangulation using the de-warped pixels. The features are compared to 3D models of the instruments to produce a set of likely poses of each instrument. If the set of poses does not produce a single pose for each instrument the set of poses is further constrained using information from previous poses and other geometric constraints such as the fact that devices are usually inserted from the top.

The processor functions 40 may also receive training images and/or graphical templates. The outputs include displays of actual video, positional metrics and graphical simulations or combinations of these displays.

The output of the motion analysis engine 35 comprises 3D data fields linked effectively as packets with the associated video images. The packets 41 are represented in FIG. 5.

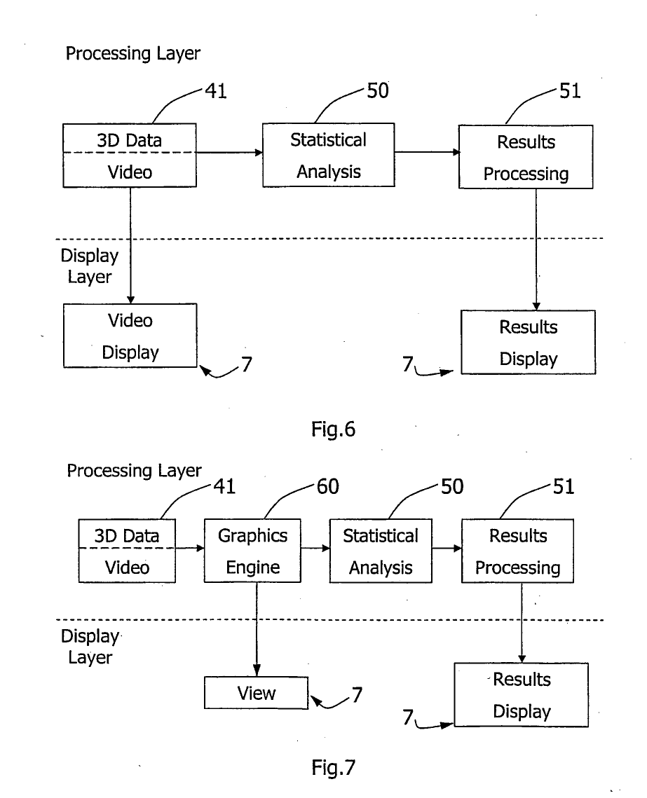

Referring to FIG. 6, in one mode of operation where real physical exercises are being manipulated using the instruments 5 the cameras 10 provide an image of the physical exercise. For the purpose of analysis the image is coupled with a data set containing the relative position and orientation of all of the instruments and objects being used in the exercise. The 3D data (generated by the engine 35) is fed to a statistical engine 50 which extracts a number of measures. A results processing function 51 uses these measures to generate of a set of metrics that score the user's performance on the task according to a series of criteria. The monitor 7 displays both the actual images and the results.

Referring to FIG. 7, a graphics engine 60 feeds into the statistical analysis function 50, in turn feeding into the results processing function 51. In this mode of operation the user's view does not consist of live images of the internals of the body form but alternatively they see a virtual reality simulation. The simulation may be an anatomically correct simulation of internal organs or may be an abstract scene containing objects to be manipulated. The 3D position and orientation data produced by tracking the instruments inside the body form is used to drive the position of instruments and objects within the virtual reality simulation and control the position and orientation of the user's viewpoint.

The graphics engine 60 renders each internal organ on an individual basis by executing an object with space, shape, lighting and texture attributes. The objects are static until the instrument is inserted. The engine 60 moves an organ surface if the 3D position of an instrument 5 enters the space occupied by the organ as modelled. A scene manager of the graphics engine 60 by default renders a static scene of static organs viewed from the position of one of the actual cameras 10. A view manager of the graphics engine accepts inputs indicating the desired camera angle. Thus the view of the simulated organs may be from any selected camera angle as required by the user and/or the application. The graphics engine also renders an instrument model and moves it according to the current 3D data. Thus, the simulated instrument is moved and the surfaces of the simulated organs are deformed according to the 3D data. Thus an illusion is created that the internals of the body form 2 contains the simulated scene.

If an instrument 5 is placed within the body form 2 its position and orientation is tracked as described above. This 3D position data is used to tell the graphics engine where to render a model of the instrument within the simulation. A stream of 3D position data keeps the virtual model of the instrument in step with the movements of the real instrument 5. Within the simulation the virtual model of the instrument 5 can then interact with the elements of the simulation with actions such as grasping, cutting or suturing thereby creating the illusion that the real instrument 5 is interacting with simulated organs within the body form.

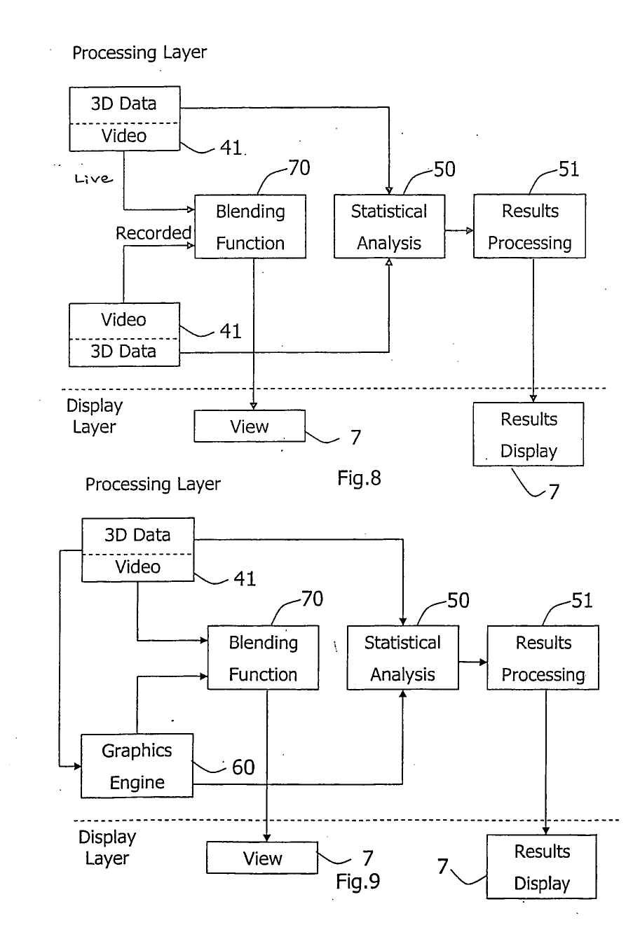

Referring to FIG. 8, a blending function 70 of the computer 6 receives the video images (in the form of the packets 41) and “blends” them with a recorded video training stream. The blending function 70 composites the images according to set parameters governing overlay and background/foreground proportions or may display the images side by side.

In parallel, the 3D data is fed to the statistical analysis function 50, in turn feeding the results processing function 51.

This mode allows a teacher to demonstrate a technique within the same physical space as experienced by the student. The blending of the images gives the student a reference image that helps them identify the physical moves. Also, the educational goals at a given point in the lesson drive dynamic changes in the degree of blending. For example, during a demonstration phase the teacher stream is at 90% and the student stream is at 10% whereas during a guided practice the teacher stream is at 50% and the student stream is at 50%. During later stages of the training i.e. independent practice, the teacher stream is at 0% and the student stream 100%. The speed of the recorded teacher stream may be controlled such that it is in step with the speed of the student. This is achieved by maintaining a correspondence between the instrument positions of the teacher and the instrument positions of the student.

In this mode, the student's performance can be compared directly with that of the teacher. This result can be displayed visually as an output of the blending function 70 or as a numerical result produced by the results processing function 51.

The display of the synchronised image streams can be blended as described above or as image streams displayed side by side.

The running of the respective image streams can be:—
interleaved: student and teacher taking turns,
synchronous: student and teacher doing things at the same time,
delayed: student or teacher stream delayed with respect to each other by a set amount, or
event-driven: the streams are interleaved, synchronised or delayed based on specific events within the image stream or lesson script.

Referring to FIG. 9, the 3D data is fed to the graphics engine 60, which in turn feeds simulated elements to the blending function 70. The simulated elements are blended with the video data to produce a composite video stream made up of both real and virtual elements. This allows for the introduction of graphical elements which can enhance the context around a real physical exercise or can allow the introduction of random surgical events (such as a bleeding vessel or fogging of the endoscope) to be generated that require an appropriate response from the student. The 3D data is also delivered to the statistical analysis engine 50 for processing as described above, for the other modes.

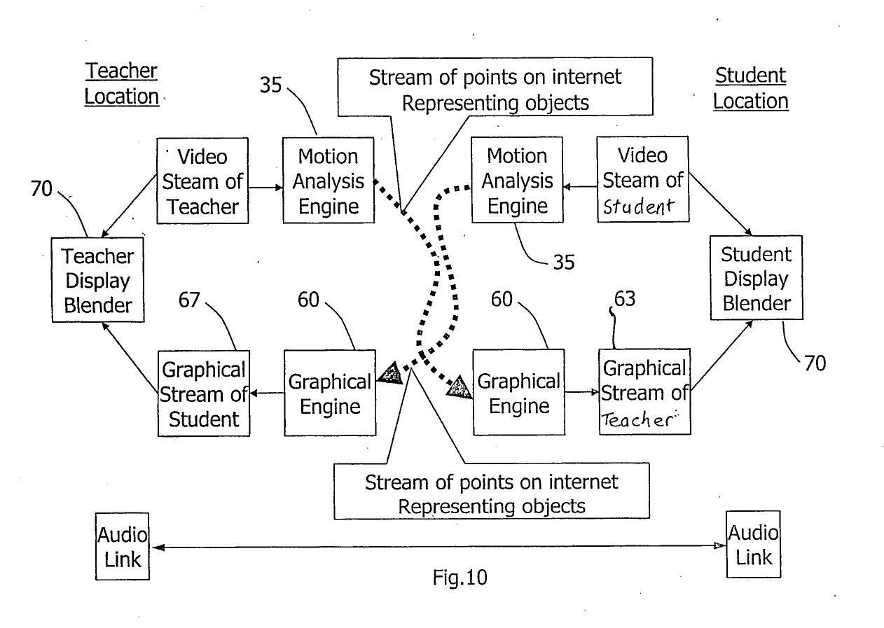

Referring to FIG. 10 an arrangement for distance learning is illustrated in which there is a system 1 at each of remote student and teacher locations. At a teacher location the video stream of packets 41 for a teacher's movement in the body form is outputted to the motion analysis engine 35 and to the student display blender. The engine 35 transmits via the Internet a low-bandwidth stream comprising high level information regarding the position and orientation of the instruments and objects being used by the teacher. The graphics engine 60 at the student location receives this position and orientation data and constructs graphical representations 63 of the teacher's instruments and objects. This graphical representation is then blended with the student's view by means of the student display blender 70. The blender 70 also receivers the student's video stream, which is also delivered to the motion analysis engine 35, which in turn transmits a low-bandwidth stream to a graphics engine 60 at the teacher location. The latter provides a student graphical stream 67 at the blender 70.

Thus, the system can deliver complex multimedia education over low bandwidth links. Currently high bandwidth links are required to deliver distance education in surgery. This is because video streams must be provided. Due to their size they are subject to the delays imposed by internet congestion. By abstracting both the student and teacher behaviour to the position and orientation of the tools and objects under manipulation, this configuration allows for distance education in surgery over low bandwidth links. A low bandwidth audio link may also be included.

This facility allows the teacher to add comments by way of textual, graphical, audio or in-scene demonstration to a recording of the student lesson.

The teacher receives either video of the lesson along with a record of the 3D position of the objects in the scene or just a record of the 3D positions of the objects in the scene. This is played back to the teacher on their workstation. The teacher can play, pause, or rewind the student's lesson. The teacher can record feedback to the student by overlaying text, overlay audio, or by using the instruments to insert their own graphical representation into the student lesson.

The simulator 1 may be used to simulate use of an endoscope. A physical model of an endoscope (which may simply be a rod) is inserted into the body form apparatus 2 and position of its tip is tracked in 3D by the motion analysis engine 35. This is treated as the position of a simulated endoscope camera, and its position and orientation is used to drive the optical axis of the view in the simulation. Both end view and angled endoscope views may be generated. The graphics engine 60 renders internal views of the simulated organs from this angle and optical axis. The view presented to the user simulates the actual view which would be seen if an actual endoscope were being used and it were inserted in a real body.

In another mode of operation, actual objects are inserted in the body form apparatus 2. Position in 3D of the instrument and/or of the objects is monitored and compared with targets. For example, one exercise may involve moving spheres from one location to another within the apparatus 2. In another example, an instrument is used for suturing an actual material, and pattern of movement of the instrument is analysed. The objects within the apparatus may incorporate sensors such as electromagnetic or optical sensors for monitoring their location within the apparatus 2. An example is an optical or electronic encoder monitoring opening of a door within the apparatus 2 by an instrument to determine dexterity of the student.

The invention is not limited to the embodiments described but may be varied in construction and detail.

1. A surgical training simulator comprising:
a body form apparatus comprising a body form allowing entry of a surgical instrument;
an illuminator;
a camera for capturing actual images of movement of the surgical instrument within the body form apparatus;
an output monitor for displaying captured images; and
a processor comprising:
a motion analysis engine for generating instrument positional data and linking the data with associated video images, and
a processing function for generating output metrics for a student according to the positional data.

2. A surgical training simulator as claimed in claim 1, wherein the simulator comprise a plurality of cameras mounted for capturing perspective views of a scene within the body form apparatus.

3. A surgical training simulator as claimed in claim 1, wherein a camera comprises an adjustment handle.

4. A surgical training simulator as claimed in claim 1, wherein the body form apparatus comprises a panel of material simulating skin, and through which an instrument may be inserted.

5. A surgical training simulator as claimed in claim 1, wherein the motion analysis engine uses a stereo triangulation technique to determine positional data.

6. A surgical training simulator as claimed in claim 5, wherein the motion analysis engine determines instrument axis of orientation and linear position on that line.

7. A surgical training simulator as claimed in claim 6, wherein the motion analysis engine monitors an instrument marking to determine degree of rotation about the axis of orientation.

8. A surgical training simulator as claimed in claim 5, wherein the motion analysis engine initially searches in a portion of an image representing a top space within the body form apparatus, and proceeds with a template matching operation only if a pixel pattern change is located in said image top portion.

9. A surgical training simulator as claimed in any of claim 5, wherein the motion analysis engine manipulates a linear pattern of pixels to compensate for camera lens warp before performing stereo triangulation.

10. A surgical training simulator as claimed in claim 1, further comprising a graphics engine for receiving the positional data and using it to generate a virtual reality simulation in a co-ordinate reference space common to that within the body form apparatus.

11. A surgical training simulator as claimed in claim 10, wherein the graphics engine renders each organ as an object having independent attributes of space, shape, lighting and texture.

12. A surgical training simulator as claimed in claim 11, wherein a scene manager of the graphics engine by default renders a static scene of all simulated organs in a static position from a camera angle of one of the actual cameras.

13. A surgical training simulator as claimed in claim 10, wherein the graphics engine renders an instrument model, and simulates instrument movement according to the positional data.

14. A surgical training simulator as claimed in claim 13, wherein the graphics engine simulates organ surface distortion if the instrument positional data indicates that the instrument enters space of the simulated organ.

15. A surgical training simulator as claimed in claim 10, wherein the graphics engine comprises a view manager which changes simulated camera angle according to user movements.

16. A surgical training simulator as claimed in claim 1, wherein the processor comprises a blending function for compositing real and recorded images according to overlay parameter values.
